(19) United States
(12) Patent Application Publication
(10) Pub. No.: US 2013/0101892 A1
(43) Pub. Date: Apr. 25, 2013

(54) FUSIBLE LINK TO CONNECT BATTERY CELLS AND MODULES

(71) Applicant: COBASYS, LLC, Orian, MI (US)

(72) Inventors: Michael W. Nickola, Rochester Hills, MI (US); Mark A. Niedzwiecki, Troy, MI (US)

(73) Assignee: COBASYS, LLC, Orion, MI (US)

(21) Appl. No.: 13/652,753

(22) Filed: Oct. 16, 2012

Related U.S. Application Data
(60) Provisional application No. 61/548,948, filed on Oct. 19, 2011.

(51) Int. Cl. H01M 2/20

(52) U.S. Cl. 429/158; 29/825

(57) ABSTRACT

A first battery includes a first and terminals having first and second reference potentials, respectively. A second battery includes a third and fourth terminals having a third and fourth reference potentials, respectively. A bus bar comprises: a first terminal contactor portion that is electrically conductive and that directly contacts one of the first and second terminals of the first battery; a second terminal contactor portion that is electrically conductive and that directly contacts one of the third and fourth terminals of the second battery; and a connecting portion that is electrically conductive, that is electrically connected between the first terminal contactor portion and the second terminal contactor portion, and that creates an open circuit between the first and second terminal contactor portions in response to current flow through the connecting portion that is greater than a predetermined current for at least a predetermined period.

### CROSS-REFERENCE TO RELATED APPLICATIONS

This application claims the benefit of U.S. Provisional Application No. 61/548,948, filed on Oct. 19, 2011. The entire disclosure of the above application is incorporated herein by reference.

### FIELD

The present disclosure relates to battery packs and more specifically to battery terminal connectors.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Battery systems may be used to provide power in a wide variety of applications. Examples of transportable applications include hybrid electric vehicles (HEV), plug-in HEVs, electric vehicles (EV), heavy duty vehicles (HDV), and vehicles with 42-volt electrical systems. Examples of stationary applications include backup power for telecommunications systems, uninterruptible power supplies (UPS), and distributed power generation applications.

Examples of the types of batteries that are used include nickel metal hydride (NiMH) batteries, lead-acid batteries, lithium batteries, lithium-ion batteries, and other types of batteries. A battery pack or system may include a plurality of battery subpacks that are connected in series, parallel, or a combination thereof. The battery subpacks may include a plurality of batteries that are connected in series, parallel, or a combination thereof.

### SUMMARY

In a feature, a first battery includes a first and terminals having first and second reference potentials, respectively. A second battery includes a third and fourth terminals having a third and fourth reference potentials, respectively. A bus bar comprises: a first terminal contactor portion that is electrically conductive and that directly contacts one of the first and second terminals of the first battery; a second terminal contactor portion that is electrically conductive and that directly contacts one of the third and fourth terminals of the second battery; and a connecting portion that is electrically conductive, that is electrically connected between the first terminal contactor portion and the second terminal contactor portion, and that creates an open circuit between the first and second terminal contactor portions in response to current flow through the connecting portion that is greater than a predetermined current for at least a predetermined period.

In another feature, a method of manufacturing a battery pack, the method comprises: providing a first battery that includes a first terminal having a first reference potential and a second terminal having a second reference potential; providing a second battery that includes a third terminal having a third reference potential and a fourth terminal having a fourth reference potential; and providing a bus bar including: a first terminal contactor portion that is electrically conductive; a second terminal contactor portion that is electrically conductive; and a connecting portion that is electrically conductive, that is electrically connected between the first terminal contactor portion and the second terminal contactor portion, and that creates an open circuit between the first and second terminal contactor portions in response to current flow through the connecting portion that is greater than a predetermined current for at least a predetermined period; and positioning the bus bar such that: the first terminal contactor portion directly contacts one of the first terminal and the second terminal of the first battery; and the second terminal contactor portion directly contacts one of the third terminal and the fourth terminal of the second battery.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example electric vehicle system including a battery pack according to the present disclosure;

FIG. 2 is a perspective view of an example prismatic cell of a battery pack according to the present disclosure;

FIG. 3 is a perspective view including a plurality of battery cells and bus bars according to the present disclosure;

FIG. 4 is a perspective view of a bus bar according to the present disclosure;

FIG. 5 includes example top and perspective views of a bus bar including two terminal contactor portions and a connecting portion according to the present disclosure;

FIG. 6 is a table with example values of period until open circuit for aluminum connecting portions with different cross-sectional areas and different amounts of current according to the present disclosure;

FIG. 7 is a perspective view including bus bars having terminal contactor portions and connecting portions that are made from the same material according to the present disclosure;

FIG. 8 is a perspective view including bus bars having terminal contactor portions that are made from one or more materials and connecting portions that are made from one or more different materials according to the present disclosure; and

FIG. 9 includes a perspective view including bus bars including connecting portions that each include multiple different electively conductive portions according to the present disclosure.

### DETAILED DESCRIPTION

A battery pack includes a plurality of individual batteries. One or more bus bars connect the batteries of the battery pack in series, parallel, or a combination thereof. The batteries may be connected, for example, to enable the battery pack to provide one or more different outputs (e.g., voltage and/or current) than the batteries outputs individually.

Under some circumstances, current through one or more bus bars may be greater than a predetermined current. Each of the bus bars of the battery pack is designed to open-circuit when current is greater than the predetermined current for a predetermined period. Characteristics (e.g., dimensions and/or composition) of the bus bar can be selected based on the predetermined current and/or the predetermined period.

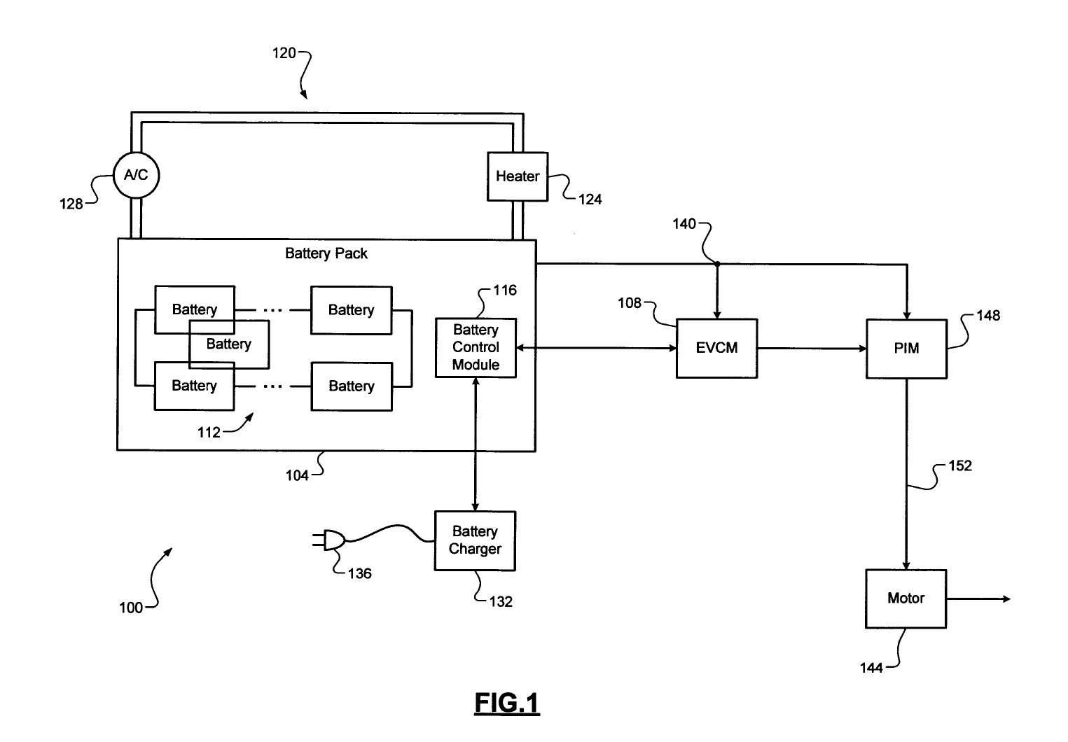

Referring now to FIG. 1, an electric vehicle 100 includes a battery pack 104 and an electric vehicle control module (EVCM) 108. The battery pack 104 includes a plurality of individual batteries 112 and a battery control module 116. The battery control module 116 controls various functions of the battery pack 104 and monitors and collects various characteristics of the battery pack 104. While only the battery pack 104 is shown, multiple battery packs may be included and connected in series, parallel, or a combination thereof.

For example, the battery control module 116 monitors characteristics including, but not limited to, voltage, current, and/or one or more temperatures associated with the battery pack 104. The battery control module 116 may determine performance variables of the battery pack 104 based on the characteristics. For example only, the battery control module 116 may estimate a state of charge (SOC) of the battery pack 104 based on the voltage, current, and temperature of the battery pack 104. The battery control module 116 may additionally or alternatively determine one or more other performance variables based on the voltage, current, and/or temperature of the battery pack 104.

The battery control module 116 may also control heating and cooling of the battery pack 104. The battery control module 116 may initiate heating and/or cooling of the battery pack 104 based on the temperature. For example, a coolant system 120 may provide liquid coolant that flows through the battery pack 104 to heat and cool the battery pack 104. The coolant system 120 may include a heater 124 and a cooling device 128 (e.g., an air conditioning compressor or a thermoelectric cooler). The heater 124 may heat the coolant when the temperature of the battery pack 104 is less than a first predetermined temperature. The cooling device 128 may cool the coolant when the temperature of the battery pack 104 is greater than a second predetermined temperature.

The battery control module 116 may communicate with a battery charger 132 (e.g., a battery charger of an electric or hybrid vehicle). The battery charger 132 charges the battery pack 104 and may include a user interface (not shown) for providing visual indications (e.g., via a display) of the condition of the battery pack 104 (e.g., the SOC of the battery pack 104). The battery charger 132 includes a plug 136 that interfaces with a power source (not shown) to provide charging power to the battery pack 104 via the battery charger 132.

The EVCM 108 communicates with the battery pack 104 and the battery control module 116 to control various functions of the vehicle 100. For example, the EVCM 108 receives voltage 140 from the battery pack 104. The EVCM 108 receives information from the battery control module 116 related to, for example only, the monitored characteristics of the battery pack 104, one or more of the performance variables, and functions of the battery control module 116, the coolant system 120, and the battery charger 132.

The EVCM 108 controls a motor 144 of the vehicle 100 via a power inverter module (PIM) 148. The PIM 148 converts direct current (DC) voltage (e.g., the voltage 140) to alternating current (AC) voltage 152 and provides the AC voltage 152 to the motor 144. The motor 144 provides torque to drive wheels (not shown) of the vehicle 100. Alternatively, the motor 144 may be implemented as a DC motor, and the PIM 148 may be replaced by a motor controller that provides a DC voltage to the motor 144. In various implementations, the heating and cooling systems may be omitted. While one example vehicle configuration is shown and discussed, the present application is also applicable to vehicles with other configurations. Moreover, while the example of the vehicle 100 is shown and discussed, the present application is also applicable to non-vehicle applications.

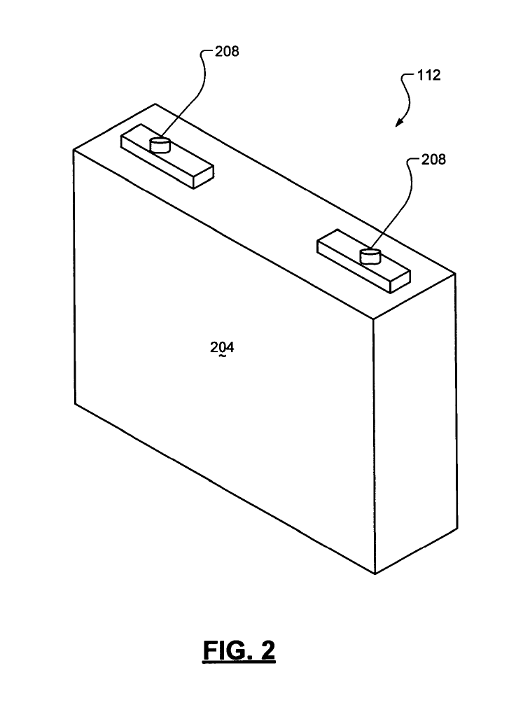

Referring now to FIG. 2, a perspective view of one of the batteries 112 (“the battery 112”) is presented. While the battery 112 is shown and will be discussed as a lithium-ion prismatic cell, the batteries 112 may be another suitable type of battery. Examples of other the types of batteries include, but are not limited to, nickel metal hydride (NiMH) batteries, lead-acid batteries, lithium batteries, pouch type batteries, and other types of batteries.

The battery 112 includes a rectangular shaped, lithium-ion cell with a housing (or can) 204. As an example, the housing 204 may be formed of aluminum, copper, and/or one or more other (electrically) conductive materials. While a rectangular shaped battery is shown and discussed, the batteries 112 may be another suitable shape.

The battery 112 may include a pair of terminals 208. The terminals 208 may include, for example, cylindrical terminals, threaded terminals, flat terminals, or another suitable type of terminal. The battery 112 may be charged and electrical energy may be drawn from the battery 112 via the terminals 208. One or neither of the terminals 208 may be electrically connected to the housing 204. Where one of the terminals 208 is connected to the housing 204, a reference potential (voltage) of the housing 204 may be approximately equal to the reference potential at the one of the terminals 208.

The terminals 208 of the battery 112 and the terminals of one or more other batteries can be connected in series, parallel, or combinations thereof to form a battery pack. One or more battery packs may be electrically connected in series, parallel, or combinations thereof, and so on.

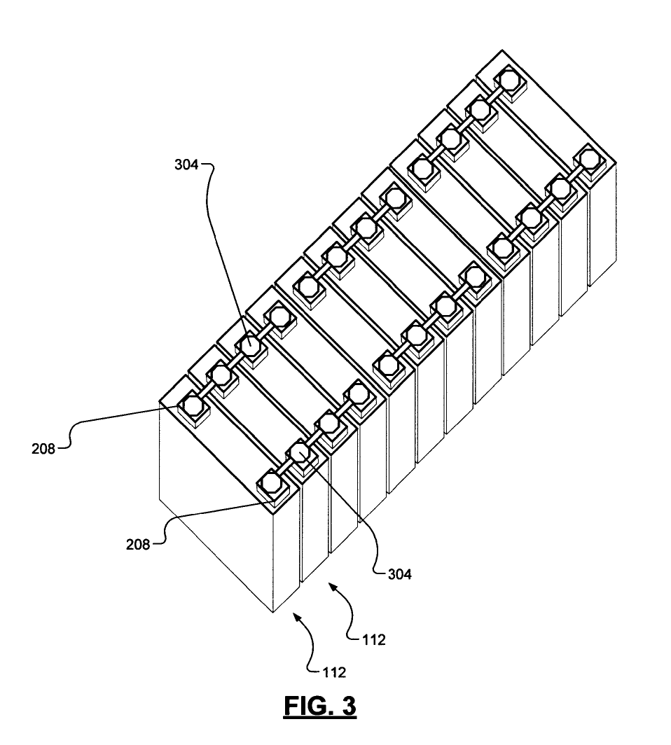

Referring now to FIG. 3, a perspective view including examples of the batteries 112 of the battery pack 104. The batteries 112 of the battery pack 104 are connected by electrically conductive bus bars 304. While multiple bus bars 304 are shown, the batteries of a battery pack may be connected by one or more bus bars. While the bus bars 304 are shown as connecting terminals of four of the batteries 112, a bus bar may connect terminals of two or more batteries.

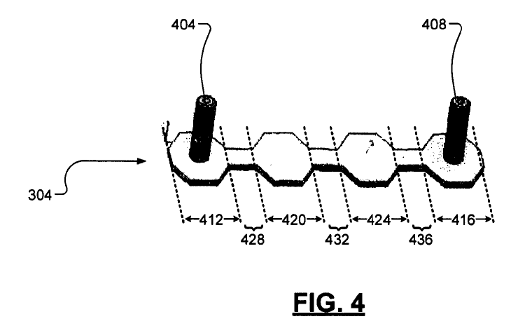

FIG. 4 includes a perspective view including one of the bus bars 304 (“the bus bar 304”) and terminals 404 and 408 of two different batteries. The bus bar 304 includes terminal contactor portions 412 and 416. The terminal contactor portions 412 and 416 contact the terminals 404 and 408 of the two different batteries. The terminal contactor portions 412 and 416 are each formed from electrically conductive material, such as aluminum, copper, and/or one or more other suitable electrically conductive materials.

The bus bar 304 may also include one or more additional terminal contactor portions, such as additional terminal contactor portions 420 and 424. While the two additional terminal contactor portions 420 and 424 are shown and described, the bus bar 304 may not include any additional terminal contactor portions, or the bus bar 304 may include one or more additional terminal contactor portions.

The additional terminal contactor portions are each formed from electrically conductive material, such as aluminum, copper, and/or one or more other suitable electrically conductive materials. Each of the additional terminal contactor portions contacts a terminal of a different battery. For example, the terminal contactor portions 412 contacts a terminal of a first battery, the terminal contactor portions 416 contacts a terminal of a second battery, the additional terminal contactor portions 420 contacts a terminal of a third battery, and the additional terminal contactor portions 424 contacts a fourth battery. While octagonal shaped terminal contactor portions are shown, the terminal contactor portions may be another suitable shape.

The bus bar 304 also includes one or more connecting portions, such as connecting portions 428, 432, and 436. Each of the connecting portions electrically connects two adjacent terminal contactor portions. For example, the connecting portion 428 electrically connects the terminal contactor portion 412 with the additional terminal contactor portion 420, and the connecting portion 432 electrically connects the additional terminal contactor portion 420 with the additional terminal contactor portion 424. The connecting portion 436 electrically connects the additional terminal contactor portion 424 with the terminal contactor portion 416. While three connecting portions are shown, the number of connecting portions of a bus bar is equal to 1 less than the number of terminal contactor portions (including additional terminal contactor portions) of that bus bar. The connecting portions 428, 432, and 436 are each designed to open circuit when current flow is greater than the predetermined current for a predetermined period.

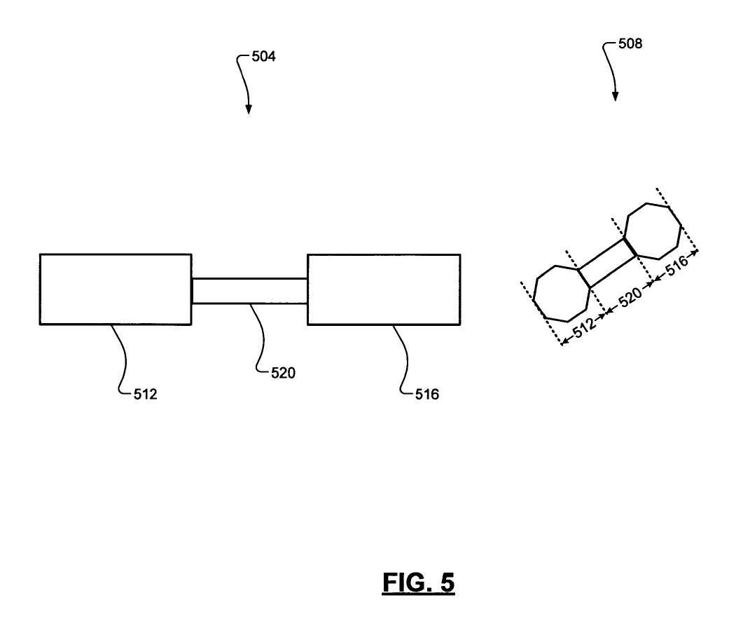

FIG. 5 includes example top and perspective views 504 and 508 including two terminal contactor portions 512 and 516 and a connecting portion 520 of a bus bar. The resistance of the (electrically conductive) connecting portion 520 can be determined using the relationship:

$$R = \frac{ρ * L}{A} ,$$

where R is the resistance of the connecting portion 520, ρ is the resistivity of the material(s) that make up the connecting portion 520 (e.g., in Ohms per millimeter), L is the length of the connecting portion 520 (e.g., in millimeters), and A is the cross-sectional area of the connecting portion 520 (e.g., in square millimeters).

A rate of change of temperature of the connecting portion 520 can be determined based on the relationship:

$$Δ T = \frac{Δ Q}{{C}_{p} * m} ;$$

wherein ΔT is the rate of change of temperature (e.g., degrees Celsius per second), ΔQ is the rate of energy input to the connecting portion 520 (e.g., Joules per second), Cₚ is the specific heat of the material(s) that make up the connecting portion 520 (e.g., in Joules per kilogram Kelvin), and m is the mass of the connecting portion 520 (e.g., in kilograms). The rate of energy input to the connecting portion 520 (SQ) can be determined based on:

P=I²*R,

where P is power, I is current through the connecting portion 520 (e.g., in amps), and R is the resistance of the connecting portion 520 (e.g., in Ohms).

The period before the connecting portion 520 will open circuit with current at the predetermined current can be determined based on the melting point temperature of the material(s) that make up the connecting portion 520. For example, a period until open circuit (PUOC) can be determined for the connecting portion 520 using the relationship:

$$PUOC = \frac{{T}_{M}}{Δ T} ,$$

where PUOC is the period until the connecting portion 520 will open circuit (e.g., in seconds), T_{M} is the melting point temperature of the material(s) that make up the connecting portion 520 (e.g., in degrees Celsius), and ΔT is the rate of change of temperature (e.g., degrees Celsius per second).

As stated above, each of the connecting portion(s) of a bus bar is designed to open circuit when current is greater than the predetermined current for the predetermined period. One or more characteristics of a connecting portion of a bus bar may be selected such that the connecting portion open circuits when current through the bus bar is greater than the predetermined current for the predetermined period. For example, the material(s) that make up the connecting portion, the length of the connecting portion, and/or the cross-sectional area of the connecting portion may be selected such that the connecting portion open circuits when current through the bus bar is greater than the predetermined current for the predetermined period. The predetermined period and the predetermined current may vary by application. Examples of materials that may be selected include, but are not limited to, aluminum, copper, solder, and other suitable materials.

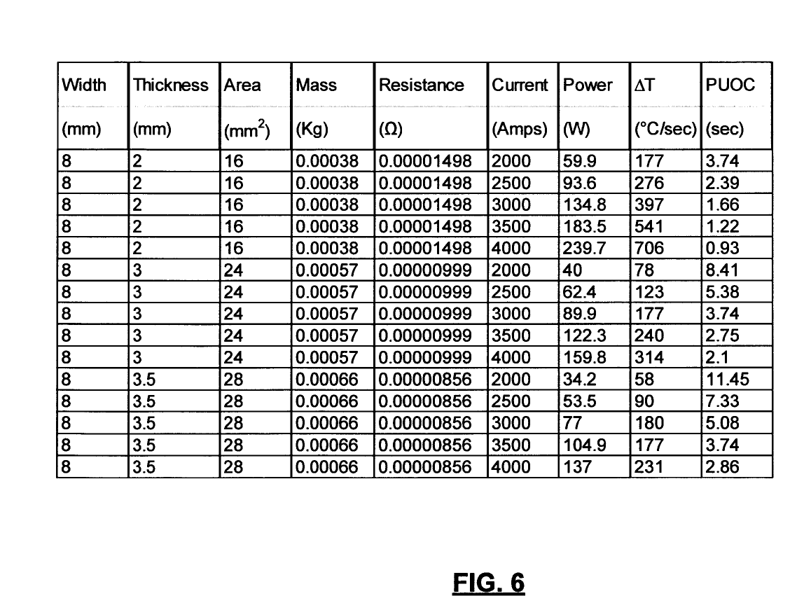

FIG. 6 includes a table with example values for the period until open for aluminum connecting portions with different cross-sectional areas and different amounts of current. The table may be used, for example, to select the dimensions of an aluminum connecting portion for a given maximum amount of current and to open circuit within a given maximum period.

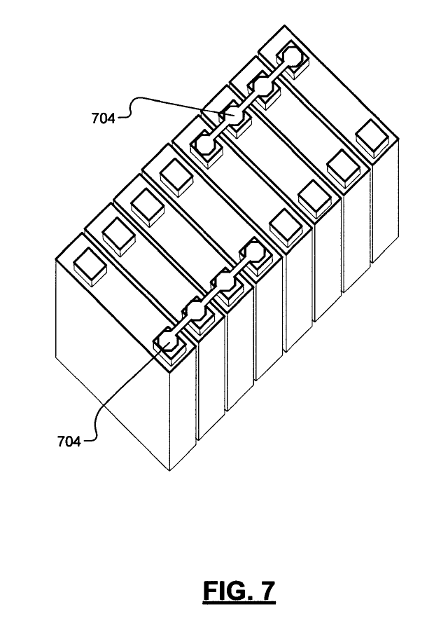

The terminal contactor portions and the connecting portion(s) of a bus bar may be made from the same material(s) in various implementations. FIG. 7 includes a perspective view including bus bars 704 having terminal contactor portions and connecting portions that are made from the same material.

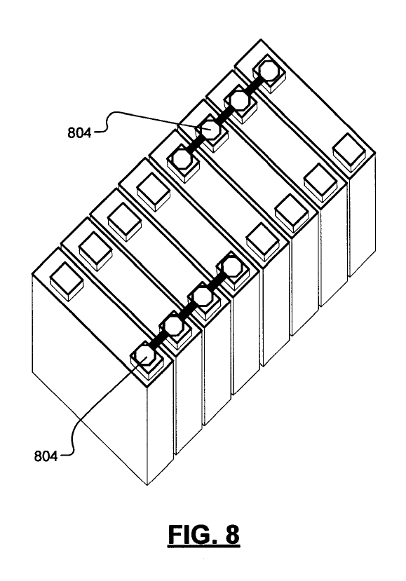

Alternatively, the terminal contactor portions may be made from one or more materials and the connecting portion(s) of a bus bar may be made from one or more materials that are different from the material(s) of the terminal contactor portions. FIG. 8 includes a perspective view including bus bars 804 having terminal contactor portions that are made from one or more materials and connecting portions that are made from one or more different materials.

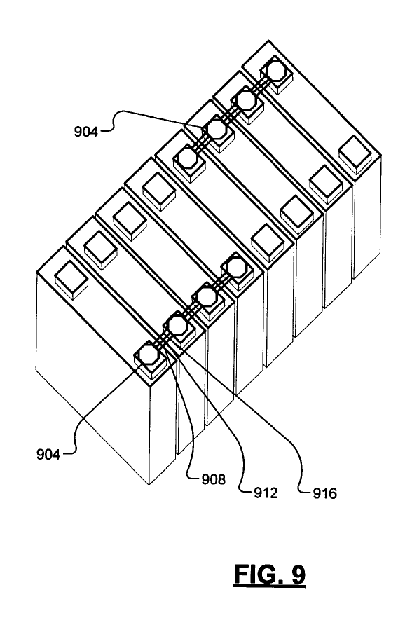

In various implementations, the connecting portions may include multiple different electrically conductive portions. FIG. 9 includes a perspective view including bus bars 904 including connecting portions 808 that each include three different electively conductive portions 908, 912, and 916. While an example implementation involving a connecting portion having three different electrically conductive portions has been presented, two or more different electrically conductive portions are possible.

Bus bars having one or more open-circuiting connecting portions enable safe connection of batteries as the connecting portion(s) will open circuit in the event of current flow being greater than the predetermined current. Current flow may be greater than the predetermined current, for example, when two batteries are short circuited, when one or more batteries is penetrated, and/or under other circumstances.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings and the specification.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); a discrete circuit; an integrated circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

What is claimed is:

1. A battery pack comprising:
a first battery that includes a first terminal having a first reference potential and a second terminal having a second reference potential;
a second battery that includes a third terminal having a third reference potential and a fourth terminal having a fourth reference potential; and
a bus bar comprising:
a first terminal contactor portion that is electrically conductive and that directly contacts one of the first terminal and the second terminal of the first battery;
a second terminal contactor portion that is electrically conductive and that directly contacts one of the third terminal and the fourth terminal of the second battery; and
a connecting portion that is electrically conductive, that is electrically connected between the first terminal contactor portion and the second terminal contactor portion, and that creates an open circuit between the first and second terminal contactor portions in response to current flow through the connecting portion that is greater than a predetermined current for at least a predetermined period.

2. The battery pack of claim 1 wherein a cross-sectional area of the connecting portion corresponds to the predetermined current and the predetermined period.

3. The battery pack of claim 1 wherein the connection portion is made from an electrically conductive material that is selected based on the predetermined current and the predetermined period.

4. The battery pack of claim 1 wherein the connecting portion consists of one electrical conductor that is electrically connected between the first terminal contactor portion and the second terminal contactor portion.

5. The battery pack of claim 1 wherein the connecting portion includes a plurality of electrical conductors that are electrically connected between the first terminal contactor portion and the second terminal contactor portion.

6. The battery pack of claim 1 wherein the connecting portion is made of aluminum.

7. The battery pack of claim 1 wherein the connecting portion is made of copper.

8. The battery pack of claim 1 wherein the connecting portion is made of a solder.

9. The battery pack of claim 1 wherein the connecting portion includes a plurality of electrically conductive materials.

10. The battery pack of claim 1 wherein the first and second terminal contactors are made from an electrically conductive material, and
wherein the connecting portion is made from the electrically conductive material.

11. The battery pack of claim 1 wherein the first and second terminal contactors are made from a first electrically conductive material, and
wherein the connecting portion is made from a second electrically conductive material that is different than the first electrically conductive material.

12. A method of manufacturing a battery pack, the method comprising:
providing a first battery that includes a first terminal having a first reference potential and a second terminal having a second reference potential;
providing a second battery that includes a third terminal having a third reference potential and a fourth terminal having a fourth reference potential; and
providing a bus bar including:
a first terminal contactor portion that is electrically conductive;
a second terminal contactor portion that is electrically conductive; and
a connecting portion that is electrically conductive, that is electrically connected between the first terminal contactor portion and the second terminal contactor portion, and that creates an open circuit between the first and second terminal contactor portions in response to current flow through the connecting portion that is greater than a predetermined current for at least a predetermined period; and
positioning the bus bar such that:
the first terminal contactor portion directly contacts one of the first terminal and the second terminal of the first battery; and
the second terminal contactor portion directly contacts one of the third terminal and the fourth terminal of the second battery.

13. The method of claim 12 further comprising selecting characteristics of the bus bar based on the predetermined current and the predetermined period.

14. The method of claim 12 further comprising selecting a cross-sectional area of the connecting portion based on the predetermined current and the predetermined period.

15. The method of claim 12 further comprising selecting a resistance of the connecting portion based on the predetermined current and the predetermined period.

16. The method of claim 12 further comprising selecting a composition of the connecting portion based on the predetermined current and the predetermined period.

17. The method of claim 12 wherein the connecting portion consists of one electrical conductor that is electrically connected between the first terminal contactor portion and the second terminal contactor portion.

18. The method of claim 12 wherein the connecting portion includes two or more electrical conductors that are electrically connected between the first terminal contactor portion and the second terminal contactor portion.

19. The method of claim 12 wherein the first and second terminal contactors are made from an electrically conductive material, and
wherein the connecting portion is made from the electrically conductive material.

20. The method of claim 12 wherein the first and second terminal contactors are made from a first electrically conductive material, and
wherein the connecting portion is made from a second electrically conductive material that is different than the first electrically conductive material.
